(19) United States
(12) Patent Application Publication
(10) Pub. No.: US 2011/0013492 A1
(43) Pub. Date: Jan. 20, 2011

(54) Chronograph timepiece

(76) Inventors: Kazumi Sakumoto, Chiba-shi (JP); Kosuke Yamamoto, Chiba-shi (JP); Tomohiro Ihashi, Chiba-shi (JP); Saburo Manaka, Chiba-shi (JP); Takanori Hasegawa, Chiba-shi (JP); Hiroshi Shimizu, Chiba-shi (JP); Keishi Honmura, Chiba-shi (JP); Kazuo Kato, Chiba-shi (JP); Kenji Ogasawara, Chiba-shi (JP); Akira Takakura, Chiba-shi (JP); Eriko Noguchi, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/803,562

(22) Filed: Jun. 29, 2010

(30) Foreign Application Priority Data
Jun. 30, 2009 (JP) 2009-155833
Nov. 11, 2009 (JP) 2009-258410

(51) Int. Cl. G04B 19/04

(52) U.S. Cl. 368/80

(57) ABSTRACT

A chronograph timepiece makes it possible to make sure that it normally operates at the time of an initial starting operation such as system resetting without having to perform a difficult operation or the like. When a system reset signal is input to a system reset terminal and it is detected that initial starting has been effected, a processing unit enables a time hand and a chronograph hand to move after permitting the time hand to perform a predetermined demonstration hand movement when both a start/stop switch and a reset switch have not been simultaneously operated; when these switches have been simultaneously operated, the processing unit enables the time hand and the chronograph hand to move without permitting demonstration hand movement.

### BACKGROUND OF THE INVENTION

1. Field of the Invention

The present invention relates to a chronograph timepiece having a time indicating function and a time measuring function.

2. Description of the Related Art

Conventionally, there has been developed a chronograph timepiece of the type in which a plurality of drive motors are mounted to individually drive a plurality of indicator hands and which is endowed with a time information displaying function as the basic function and, further, with a time measuring function (chronograph function) as an additional function, wherein the driving of the indicator hands is electrically effected by the drive motors, and the zero-restoring of chronograph hands is effected by a mechanical mechanism such as hearts (See, for example, Japanese Patent No. 4,244,643).

The chronograph timepiece disclosed in Japanese Patent No. 4,244,643 involves an inner processing circuit and control software that are rather complicated and sophisticated, so that, as compared with a simple ordinary timepiece which only indicates hour, minute, and second, the possibility of its malfunction is higher.

Such malfunction is partly due to the fact that the processing at the time of initial starting when replacing the battery or when effecting system resetting is not executed correctly.

Usually, when the power source is started, the power source voltage rises from zero, so that normal starting is to be expected; it should be noted, however, that a timepiece is inherently of very low power consumption, so that when the replacement operation time (the period of time for the removal of the battery) is relatively short, there is a possibility of a delay in the reduction in voltage due to the capacitance of a capacitor or the like contained in the inner circuit, with the inner voltage until the recovery of the voltage through the replacement of the battery being below the operation limit value of a semiconductor device used in a control unit or the like of the timepiece. At this time, the control unit does not start from the initial state but is allowed to operate in the state continued from a point in time prior to the reduction in voltage, resulting in various unpredictable operational defects such as breakage of an inner register value and abnormality in the circuit operation sequence.

To avoid this, in the conventional chronograph timepiece, it has been necessary not only to confirm movement of the time indicating second hand after the replacement of the battery, but also to perform a difficult operation of making sure whether the chronograph function is capable of normal operation by actually operating an operating switch.

Further, in a case in which setting is effected on the chronograph hands so that they may not move by means of mechanical components such as hearts in the chronograph reset state, the chronograph hands cannot be operated, so that it is impossible to check the operation by the chronograph hands.

At the time of an initial starting operation such as system resetting, it might be possible to indicate normal operation by causing the time second hand to make one rotation; however, in the case in which the time second hand is interlocked with the minute hand and the hour hand, causing the time second hand to make one rotation would result in movement of the time minute hand and the time hour hand. In the case in which a reverse drive pulse is provided, advancement of time by one minute can be prevented by causing the time second hand to make normal half rotation and reverse half rotation; this, however, would necessitate a reverse drive pulse generation circuit, resulting in an increase the size of the integrated circuit (IC) constituting the drive circuit.

On the other hand, JP-A-11-258365 discloses an electronic timepiece in which a reduction in the voltage of a rechargeable power source is warned by a small second hand; the publication, however, makes no mention of an initial starting operation such as that at the time of system resetting.

### SUMMARY OF THE INVENTION

It is an aspect of the present invention to make it possible to make sure that a chronograph timepiece normally operates at the time of an initial starting operation such as system resetting without having to perform a difficult operation or the like.

According to a first aspect of the present invention, there is provided a chronograph timepiece of the type in which a time hand and a chronograph hand are electrically driven by a motor and in which, in a reset state, setting is effected by a mechanical mechanism so that the chronograph hand may not move, with the chronograph hand being driven after the releasing of the setting by the mechanical mechanism, wherein there is provided a control unit controlling the motor so as to permit the time hand to perform a predetermined normal indicating operation when initial starting is effected.

According to a second aspect of the present invention, there is provided a chronograph timepiece of the type in which time hands including a time second hand and a chronograph hand are electrically driven by a motor and in which, in a reset state, setting is effected by a mechanical mechanism so that the chronograph hand may not move, with the chronograph hand being driven after the releasing of the setting by the mechanical mechanism, wherein there is provided a normal indicating drive unit which, when initial starting is effected, drives the time second hand at a cycle different from the time indicating cycle, thereby performing normal indicating operation.

In the chronograph timepiece of the present invention, it is possible to make sure that the chronograph timepiece operates normally at the time of an initial starting operation such as system resetting without having to perform a difficult operation or the like.

### BRIEF DESCRIPTION OF THE DRAWINGS

FIG. 1 is a block diagram showing a chronograph timepiece according to an embodiment of the present invention;

FIG. 2 is a flowchart for a chronograph timepiece according to an embodiment of the present invention;

FIG. 3 is a block diagram showing a chronograph timepiece according to another embodiment of the present invention;

FIG. 4 is an explanatory view of a chronograph timepiece according to another embodiment of the present invention;

FIG. 5 is a flowchart for a chronograph timepiece according to an embodiment of the present invention;

FIG. 6 is a flowchart for a chronograph timepiece according to an embodiment of the present invention;

FIG. 7 is a flowchart for a chronograph timepiece according to an embodiment of the present invention; and

FIG. 8 is a flowchart for a chronograph timepiece according to an embodiment of the present invention.

### DESCRIPTION OF THE PREFERRED EMBODIMENTS

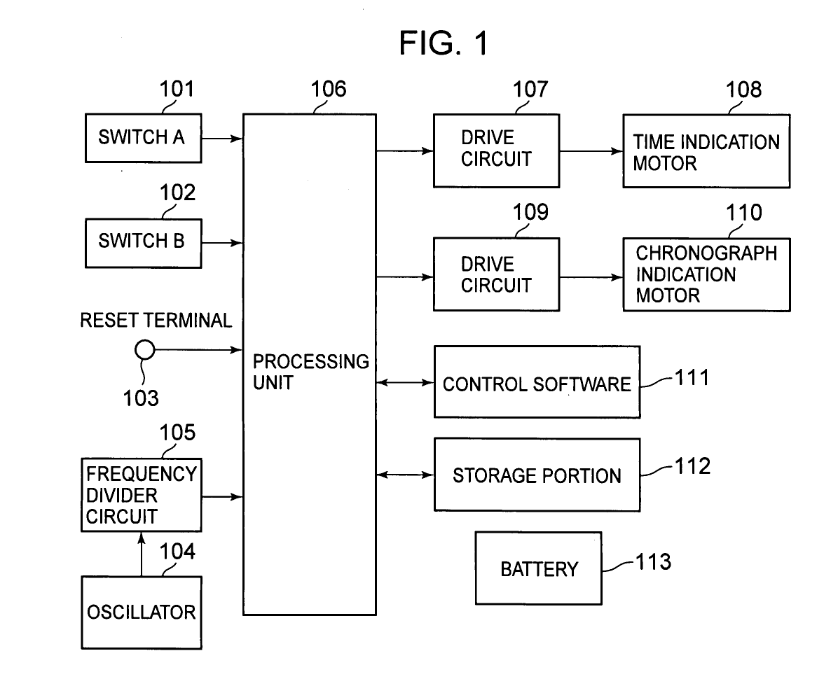

FIG. 1 is a block diagram showing a chronograph timepiece according to an embodiment of the present invention. The chronograph timepiece of this embodiment is supposed to be a chronograph timepiece in which the driving of time hands and chronograph hands are electrically effected by a motor, and in which, in a reset state, setting is effected by a mechanical mechanism such as hearts so that the chronograph hands may not move, with the chronograph hands being driven after the releasing of the setting by the mechanical mechanism.

In FIG. 1, the chronograph timepiece is equipped with a start/stop switch (A) 101 for performing the operation of starting and stopping a chronograph function, a reset switch (b) 102 for resetting the chronograph function, a system reset terminal 103 for inputting a system reset signal for resetting (system-resetting) the entire system of the chronograph timepiece, an oscillator 104 generating a signal of a predetermined frequency, a frequency divider circuit 105 effecting frequency division on the signal generated by the oscillator 104 to generate a timepiece signal serving as a reference for time measurement, and a processing unit 106 consisting of a central processing unit (CPU) and adapted to perform a processing such as control of a motor and various electronic circuits constituting the chronograph timepiece.

Further, the chronograph timepiece is equipped with a drive circuit 107 rotating a time indication motor 108 by a drive pulse corresponding to a control signal from the processing unit 106, the time indication motor 108 consisting of a stepping motor and adapted to rotate time hands (e.g., an hour hand, a minute hand, and a secondhand), a drive circuit 109 rotating a chronograph indication motor 110 by a drive pulse corresponding to the control signal from the processing unit 106, and the chronograph indication motor 110 consisting of a stepping motor and adapted to rotate chronograph hands (e.g., a chronograph minute hand and a chronograph second hand).

Further, the chronograph timepiece is equipped with a control software storage portion 111 storing software to be executed by the processing unit, a storage portion 112 storing setting data, measurement data, etc., and a battery 113 functioning as the power source of the chronograph timepiece.

Although the mechanical construction thereof is not shown, as in the invention disclosed in Japanese Patent No. 4,244,643, in the reset state, transition to which is effected through the operation of the reset switch 102, setting is mechanically effected by the mechanical mechanism such as hearts so that the chronograph hands may not move, and chronograph measurement data is reset electrically.

Here, the processing unit 106 constitutes a control unit, and the start/stop switch 101 and the reset switch 102 constitute operating units. Further, the control software storage portion 111 and the storage portion 112 constitute storage units.

The control unit may be constructed such that the time hands are permitted to perform a predetermined normal indicating operation when initial starting is effected as when a system reset signal is input to the system reset terminal 103 or when the battery 113 is replaced.

Further, the control unit may be constructed such that the time hands are permitted to perform a normal indicating operation when initial starting is effected, with the operating unit being in a predetermined state.

Further, the control unit may be constructed so as to permit the time hands to perform normal indicating operation when initial starting is effected, with a predetermined operation not being performed with the operating unit.

Further, the control unit may be constructed so as to perform hand movement of the time hands until the time hands perform normal indicating operation.

Further, the control unit may be constructed so as to allow chronograph operation until the time hands perform normal indicating operation.

Further, the control unit has a start/stop switch 101 giving an instruction to start and stop the chronograph function and a reset switch 102 giving an instruction to reset the chronograph function; and the control unit may be constructed so as to permit the time hands to perform normal indicating operation when initial starting is effected, with the start/stop switch 101 and the reset switch 102 not being operated simultaneously.

Further, the control unit has the system reset terminal 103 and may be constructed such that initial starting is effected through input of a system reset signal to the system reset terminal 103.

Further, a construction is possible in which the battery 113 is operated as the power source, with initial starting being effected through replacement of the battery 113.

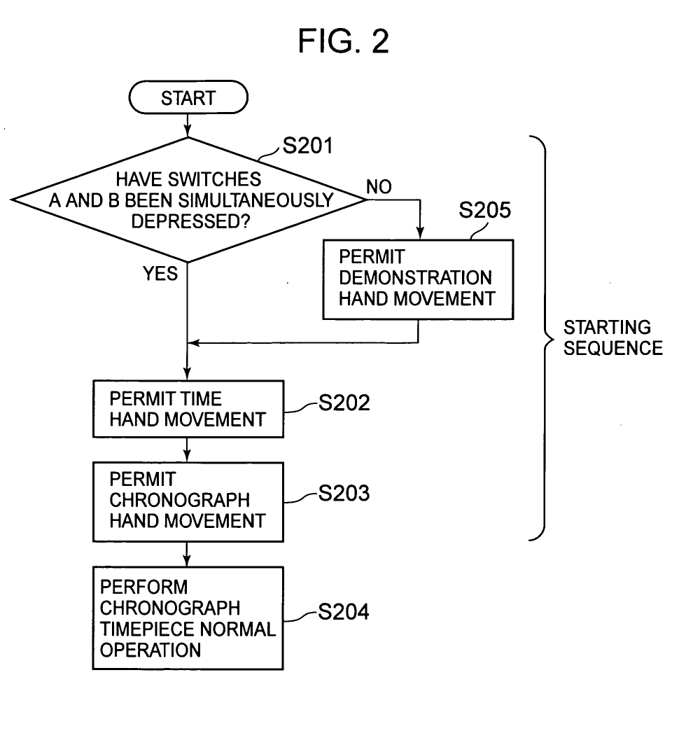

FIG. 2 is a flowchart related to the chronograph timepiece of the embodiment of the present invention; it mainly illustrates a processing conducted through execution of control software the processing unit 106 stores in the control software storage portion 111.

In the following, the operation of the chronograph timepiece of the embodiment of the present invention will be illustrated with reference to FIGS. 1 and 2.

The chronograph timepiece 1 is operated by using drive power supplied from the battery 113.

When performing normal time measuring operation, the processing unit 106 performs the measuring operation based on a timepiece signal from the frequency divider circuit 105, and the time indication motor 108 is rotated via the drive circuit 107. The time indication motor 108 rotates the time hands (not shown), and the current time is indicated by the time hands whenever necessary.

When performing chronograph operation, the user operates the start/stop switch 101 in the reset state, thereby starting the chronograph function. The processing unit 106 starts time measuring operation in response to the start operation by the start/stop switch 101, and rotates the chronograph indication motor 110 via the drive circuit 109 by an amount corresponding to the time measured. The chronograph indication motor 110 drives the chronograph hands (not shown), and the period of time that has elapsed is indicated by the chronograph hands whenever necessary.

The user operates the start/stop switch 101 at a desired point in time, thereby stopping the chronograph function to stop the time measuring operation. The period of time that has elapsed from the time measurement start to the time measurement stop is indicated by the chronograph hands.

Next, the operation at the time of system resetting will be illustrated. When it detects that the system reset signal for resetting the entire electrical system of the chronograph timepiece has been input to the system reset terminal 103 to effect initial starting, the processing unit 106 makes a judgment as to whether or not both the start/stop switch 101 and the reset switch 102 have been simultaneously operated (i.e., as to whether or not both the start/stop switch 101 and the reset switch 102 have been simultaneously depressed to attain the closed state) (step S201).

When, in the processing step S201, the processing unit 106 judges that the switches 101, 102 have not been simultaneously operated, the time hands are permitted to perform a predetermined normal indicating operation (demonstration time movement), and the time indication motor 108 is controlled such that normal indicating operation (demonstration hand movement) is executed with a predetermined timing in the normal operation thereafter or at a predetermined switch operation time (step S205), and then hand movement of the time hands and hand movement of the chronograph hands are made possible (steps S202, S203).

Via these starting processing operations, the time indication motor 108 rotates the time hands to perform the above-mentioned demonstration hand movement in response to demonstration hand movement control by the processing unit 106 with a predetermined timing or through a predetermined switching operation. As an example of the demonstration hand movement operation at this time, the second hand may be caused to make one rotation.

After the control of the demonstration hand movement has been effected, normal hand movement of the time hands and the chronograph hands become possible, and the operation of indicating the current time and a normal operation processing of the chronograph timepiece such as time measurement operation are conducted (step S204).

In this way, in the case in which the operating switches 101, 102 have not been simultaneously operated, the processing unit 106 permits the demonstration hand movement of the processing step S205, whereby the user is enabled to confirm the demonstration hand movement operation with a predetermined timing thereafter or at the time of a predetermined switch operation. Further, until the demonstration hand movement is started, the time hand movement and the chronograph hand movement are permitted, so that it is possible to check the operating condition after the starting through confirming the time hand movement operation.

On the other hand, when, in the processing step S201, the processing unit 106 judges that the switches 101, 102 have been simultaneously operated, it does not permit demonstration hand movement, and enables the hand movement of the time hands (step S202) or enables the hand movement of the chronograph hand (step S203).

As a result, there is no need for the waiting period until the confirmation of a predetermined timing for demonstration hand movement or the confirmation of execution of demonstration hand movement through a predetermined operation, making it possible for the time hands and the chronograph hands to immediately perform normal operation without involving an increase in inspection time at the time of the production of the timepiece; and the operation of indicating the current time and a normal operation processing of the chronograph timepiece such as time measuring operation are conducted (step S204).

As described above, in the chronograph timepiece of this embodiment, the driving of the time hands and the chronograph hands are electrically effected by a motor, and, in the reset state, setting is effected by a mechanical mechanism so that the chronograph hands may not move, with the driving of the chronograph hands being effected after the releasing of the setting by the mechanical mechanism; in this chronograph timepiece, when the processing unit 106 detects that initial starting has been effected through input of the system reset signal to the system reset terminal 103, the time hands are permitted to perform a predetermined demonstration hand movement in the case in which both the start/stop switch 101 and the reset switch 102 have not been simultaneously operated, making it possible to effect movement of the time hands and movement of the chronograph hands; and, in the case in which the switches 101, 102 have been simultaneously operated, movement of the time hands and of the chronograph hands is made possible without performing demonstration hand movement. In the case in which demonstration hand movement is permitted, the processing unit 106, thereafter, controls the time indication motor 108 such that the demonstration hand movement operation by the time hands is executed with a predetermined timing or through a predetermined switch operation.

In this way, it is indicated that normal operation is possible at the time of initial starting by using the time hands at the time of initial starting operation, so that there is no need to perform a difficult operation or the like, and it is possible to make sure that an initial starting operation such as that at the time of battery replacement has been normally effected, making it possible to easily make sure that the chronograph timepiece is capable of normal operation.

Further, until the demonstration hand movement is effected, the processing unit 106 enables the operation of the chronograph timepiece, so that it is possible to check the operating condition of the chronograph timepiece through checking of the operation of the time hands.

Further, since it possible to prohibit the demonstration hand movement through a predetermined switch operation, it is possible to prevent an increase in inspection time at the time of the production of the timepiece.

Further, also in the case in which setting is effected on the chronograph hands by a mechanical mechanism such as hearts, it is possible to make sure that the processing unit 106 has been started from the initial state through checking of the hand movement using the time hands.

While in the above-described example of this embodiment, system resetting is effected through supplying a system reset signal to the system reset terminal 103 as an example of the initial starting, this may also be conducted when the battery 113 is removed for replacement.

As the predetermined switch operation for performing demonstration hand movement, it is also possible to adopt a combination using a crown, etc. apart from the use of the start/stop switch 101.

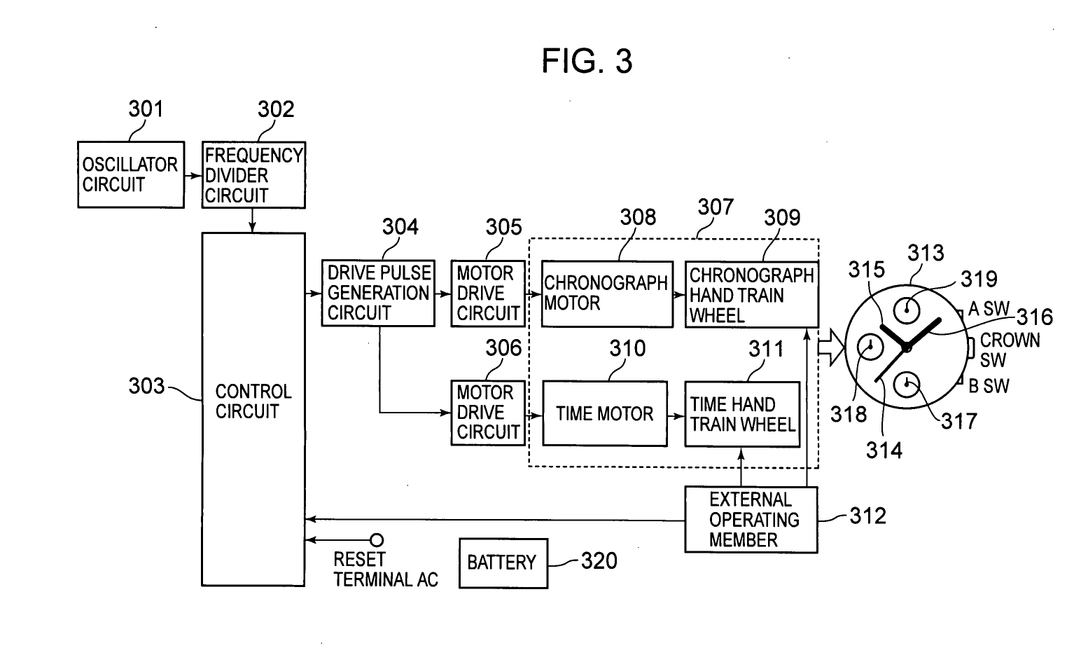

FIG. 3 is a block diagram showing a chronograph timepiece according to another embodiment of the present invention.

In FIG. 3, the chronograph timepiece is equipped with an oscillator circuit 301 generating a signal of a predetermined frequency, a frequency divider circuit 302 effecting frequency division on the signal generated by the oscillator circuit 301 to generate a timepiece signal serving as a reference for time measurement, a control circuit 303 performing control such as the control of various electronic circuit components constituting an electronic timepiece and the control for changing the drive pulse, and a drive pulse generation circuit 304 generating drive pulses for driving the time hands and drive pulses for driving the chronograph hands corresponding to the control signal from the control circuit 303. The control circuit 303 is equipped with a system reset terminal AC for inputting a system reset signal (e.g., a power source voltage VDD signal) for effecting system resetting (all clearing) on the entire system of the chronograph timepiece.

Further, the chronograph timepiece is equipped with a motor drive circuit (second motor drive circuit) 305 driving a chronograph motor (second stepping motor) 308 in a rotary drive portion 307 by a chronograph hand drive pulse from the drive pulse generation circuit 304, and a motor drive circuit (first motor drive circuit) 306 driving a time motor (first stepping motor) 310 in the rotary drive portion 307 by a time hand drive pulse from the drive pulse generation circuit 304.

Further, the chronograph timepiece is equipped with the chronograph motor 308 driving the chronograph hands, a chronograph hand train wheel 309 transmitting the rotation of the chronograph motor 308 to the chronograph hands, a time motor 310 driving the time hands, a time hand train wheel 311 transmitting the rotation of the time motor 310 to the time hands, and an external operating member 312 for performing the operation or the like of the chronograph train wheel 309 and the time hand train wheel 311. The chronograph motor 308, the chronograph hand train wheel 309, the time motor 310, and the time hand train wheel 311 are components of the rotary drive portion 307.

Further, the chronograph timepiece is equipped with an analog display portion 313 driven by the rotary drive portion 307 and adapted to display the measurement time and the current time by the chronograph hands and the time hands.

The analog display portion 313 is equipped with chronograph hands (a chronograph hour hand 318, a chronograph minute hand 319, and chronograph second hand 314) indicating the measured time, and time hands (a time hour hand 315, a time minute hand 316, and a time second hand (a small second hand in this embodiment) 317) indicating the current time. The chronograph hands 314, 318, and 319 are rotated by the chronograph motor 308 and the chronograph hand train wheel 309, and the time hands 315, 316, and 317 are rotated by the time motor 310 and the time hand train wheel 311.

Further, the chronograph timepiece is equipped with a start/stop switch ASW giving an instruction to start and stop time measuring operation, a crown SW, and a reset switch BSW for resetting the time measuring operation. The start/stop switch ASW, the reset switch BSW, and the crown SW constitute an external operating member 312. A battery 320 serves as the power source of the chronograph timepiece.

The chronograph motor 308 and the time motor 310 are stepping motors, and have, for example, a stator having a rotor accommodation hole and a positioning portion for determining the stop position for a rotor, the rotor arranged within the rotor accommodation hole, and a coil; they are well-known 2-polarity PM (permanent magnet) type stepping motors in which alternating signals are supplied to the coil to generate a magnetic flux in the stator to thereby rotate the rotor, and in which the rotor is stopped at a position corresponding to the positioning portion. By alternately supplying drive signals of different polarities to the drive coil of each stepping motor, the rotor is continuously rotated in a fixed direction by a predetermined angle (e.g., 180 degrees) at one time.

As shown in FIG. 1, in the chronograph timepiece of the other embodiment, the driving of the time hands including the time second hand 317 and the chronograph hands is electrically effected by the motors 308, 310; in the reset state, setting is effected by a well-known mechanical mechanism (not shown) so that the chronograph hands 314, 318, 319 may not move, and the driving of the chronograph hands 314, 318, 319 is effected by the motor 308 after the releasing of the setting by the mechanical mechanism.

The oscillator circuit 301 and the frequency divider circuit 302 constitute a signal generation unit. Further, the oscillator circuit 301, the frequency divider circuit 302, the control circuit 303, the drive pulse generation circuit 304, the motor drive circuits 306, 306 and the rotation drive unit 307 constitute a normal indicating drive unit.

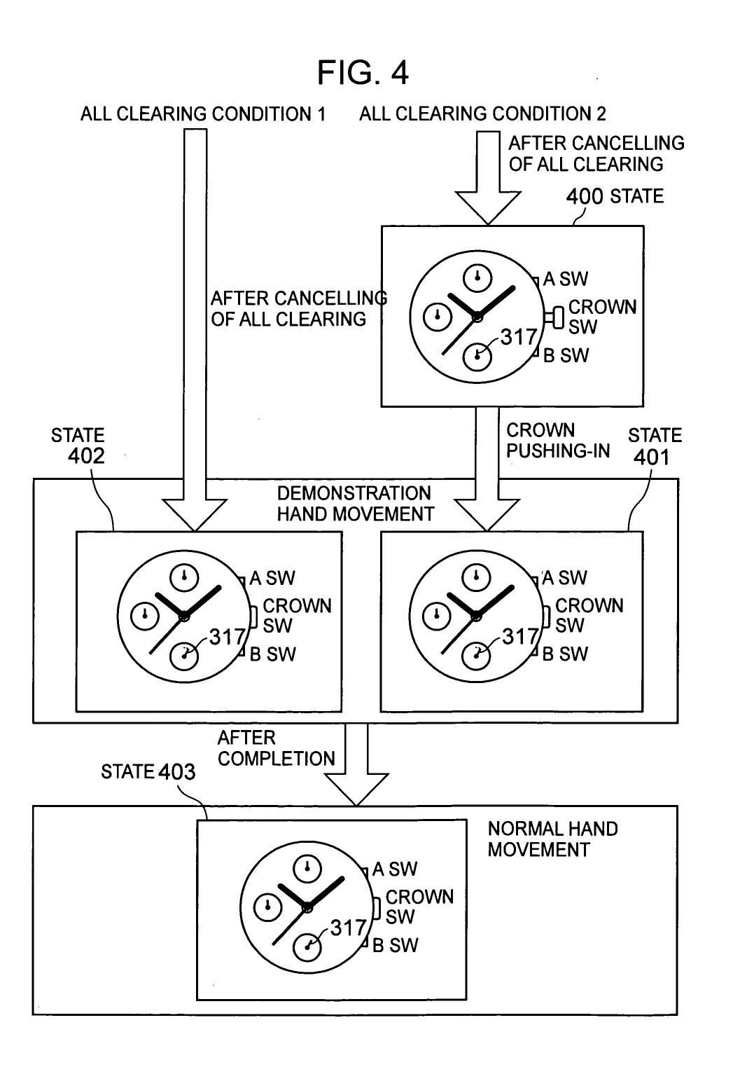

FIG. 4 is an explanatory view illustrating the outline of the operation of the other embodiment of the present invention.

In FIG. 4, the following conditions are prepared as conditions (all clearing conditions) for entering into initial starting (also referred to as system resetting or all clearing); when one of the all clearing condition is satisfied, initial starting is effected, and there is effected a normal indicating operation indicating that the initial starting has been performed.

All clearing condition 1 is a case (1) in which a system reset signal (e.g., power source voltage VDD) is supplied to the system reset terminal AC or a case (2) in which the battery 320 is replaced, with the crown SW being in the retracted state.

All clearing condition 2 is a case (1) in which the reset switch BSW has been depressed for not less than a predetermined period of time (e.g., two seconds), a case (2) in which the system reset signal (e.g., the power source voltage VDD) is supplied to the system reset terminal AC, or a case (3) in which the battery 320 is replaced, with the crown SW being in the drawn-out state.

When it is judged that all clearing state 1 has been satisfied (i.e., initial starting has been effected), the control circuit 303 cancels the all clearing processing after the all clearing processing, and then control the motor drive circuit 306 such that the time second hand 317 performs normal indicating operation (condition 402). In the normal indicating operation, drive control is effected such that the time second hand 317 performs a hand movement operation (demonstration hand movement) for a predetermined period of time (e.g., 10 seconds) at a cycle different from the normal time indicating cycle. The motor drive circuit 306 drives the time motor 310 such that the time second 317 performs the hand movement for the predetermined period of time at a cycle different from the time indicating cycle. For example, in the demonstration hand movement, the time secondhand 317 is driven for every predetermined seconds (e.g., n seconds (two seconds in this embodiment)) collectively for the predetermined seconds within a predetermined period of time before the predetermined seconds have elapsed (n-second hand movement).

When it is judged that all clearing condition 2 has been satisfied (that is, initial starting has been effected), the control circuit 303 cancels the all clearing processing after the all clearing processing, and is then kept on standby with crown SW drawn out (state 400). In this state, it is impossible to rotate the time hands 315 through 317, so that the normal indicating operation by the second hand 317 cannot be performed. When it is judged in state 400 that the crown SW has been pushed in, the control circuit 303 controls the motor drive circuit 306 such that the time second hand 317 performs the normal indicating operation (state 401). As in the above case, in this case also, in the normal indicating operation, drive control is effected such that the time secondhand 317 performs a hand movement operation (demonstration hand movement) different from the normal time display operation for a predetermined period of time (e.g., 10 seconds). The motor drive circuit 306 drives the time motor 310 such that the time second hand 317 performs a hand movement operation (e.g., n-second hand movement) different from the time indicating operation for the predetermined period of time.

Next, when it is judged that the condition for completing the normal indicating operation has been established, the control circuit 303 controls the motor drive circuit 306 so as to complete the normal indicating operation. In the other embodiment, the condition for completion is a case in which in state 402 or 401 the predetermined period of time (e.g., 10 seconds) has elapsed from the start of the normal indicating operation, or a case in which the operation of drawing out the crown SW has been conducted during the normal indicating operation.

In response to the control to complete the normal indicating operation by the control circuit 303, the motor drive circuit 306 drives the time motor 310 such that the time second hand 317 stops the demonstration hand movement to perform hand movement at the time indicating cycle. In the state in which the crown SW has been pushed in, the time second hand 317 is switched from the demonstration hand movement to the time display hand movement, and the normal time display (normal hand movement) is conducted at a rate of 1 step/sec (state 403).

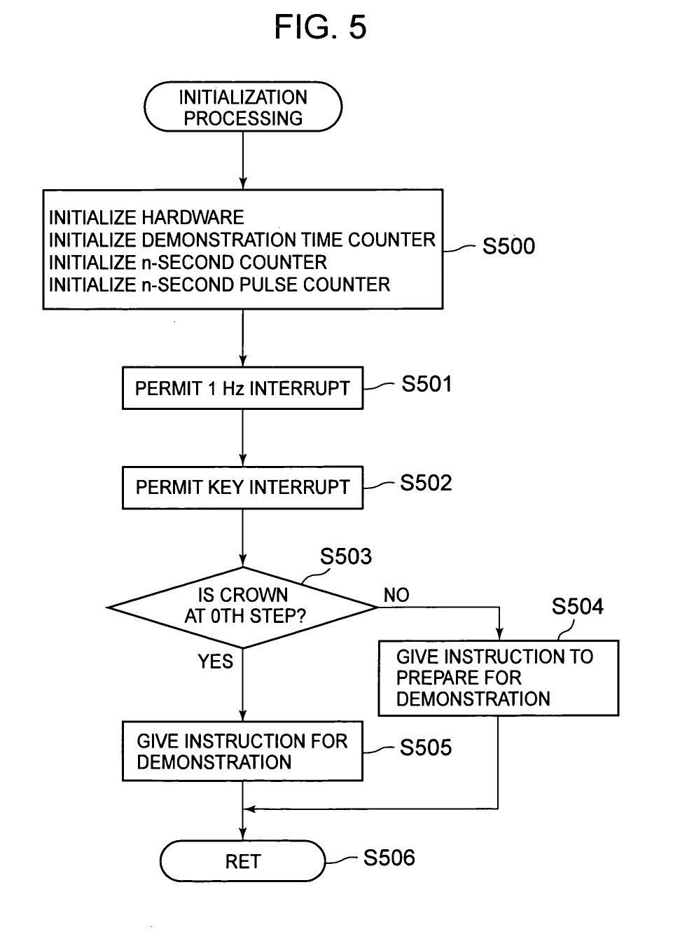

FIGS. 5 through 8 are flowcharts illustrating the processing in the other embodiment, mainly showing the processing by the control circuit 303.

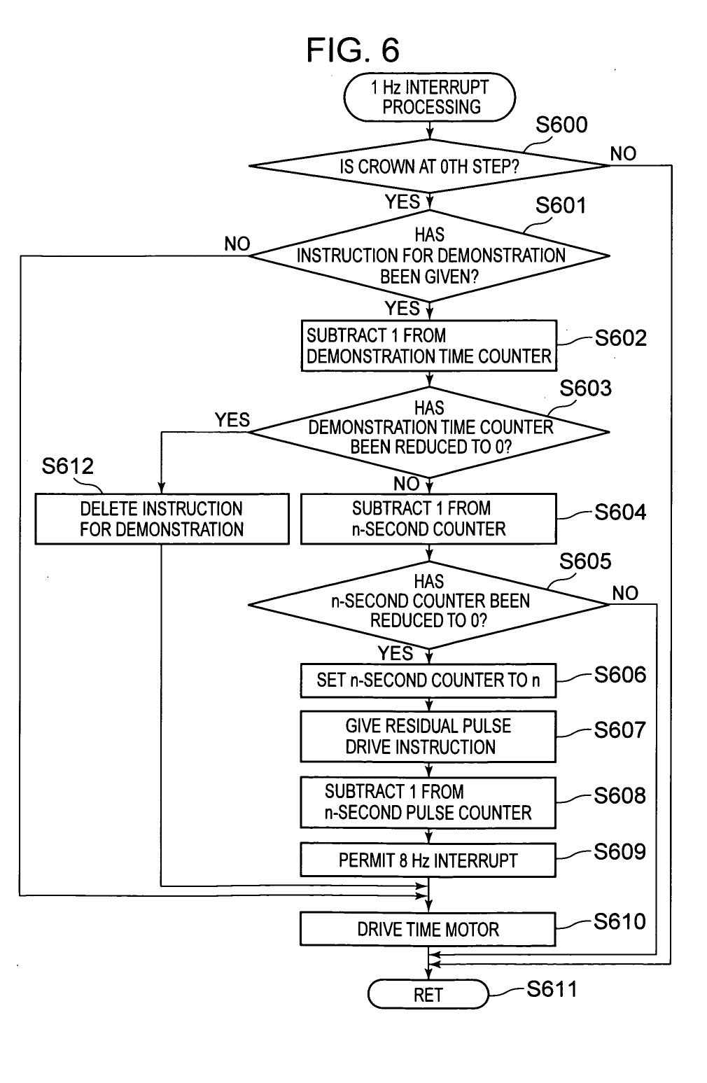

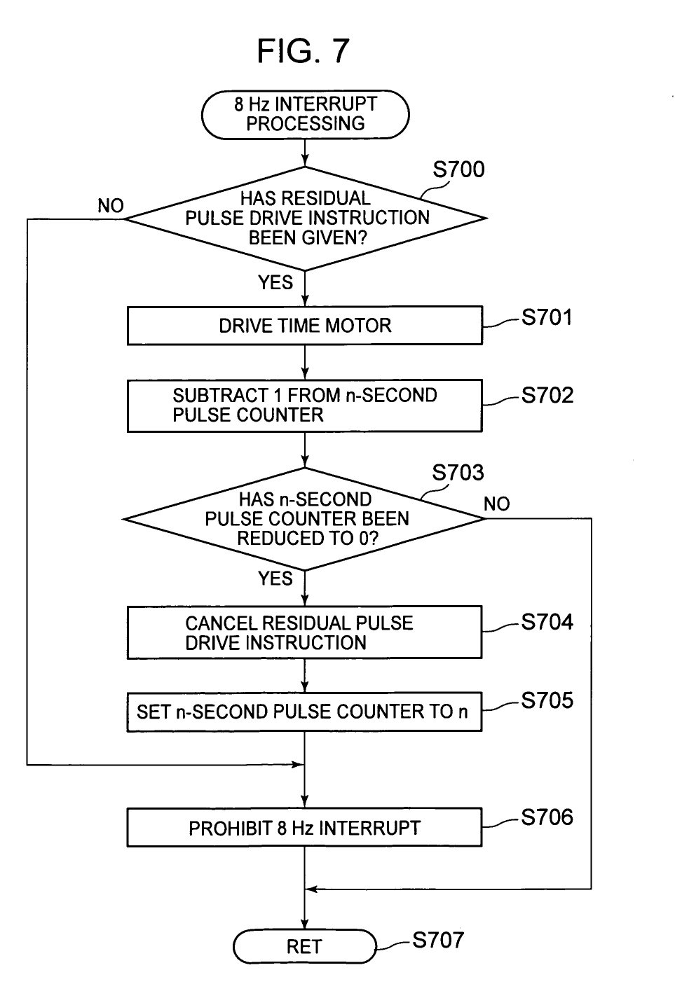

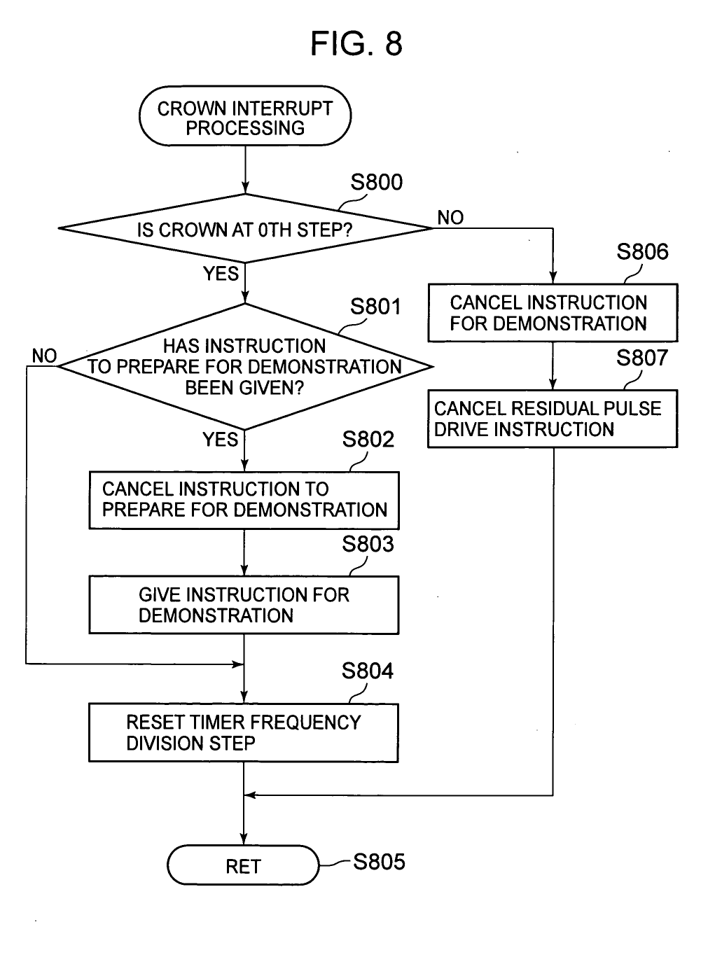

FIG. 5 is a flowchart illustrating the general processing at the time of initial starting, FIG. 6 is a flowchart illustrating a 1 Hz interrupt processing in the processing of FIG. 5, FIG. 7 is a flowchart illustrating an 8 Hz interrupt processing in the processing of FIG. 6, and FIG. 8 is a flowchart illustrating an interrupt processing through operation of the crown SW.

In the following, the operation of the chronograph timepiece of the other embodiment of the present invention will be described in detail with reference to FIGS. 3 through 8.

During normal operation, the chronograph timepiece performs time measuring operation or time measurement operation as follows.

First, the oscillator circuit 301 generates a reference clock signal of a predetermined frequency, and the frequency divider circuit 302 effects frequency division on the signal generated by the oscillator circuit 301 to output a timepiece signal serving as a reference for time measurement to the control circuit 303.

When performing the time indicating operation, the control circuit 303 performs time measuring operation based on the timepiece signal, and each time a predetermined time indicating cycle (e.g., 1 second) arrives, the drive pulse generation circuit 304 controls the time motor 310 so as to rotate the same via the motor drive circuit 306. As a result, the time motor 310 rotates the time hands 315, 316, 317 via the time hand train wheel 311 at the time indicating cycle. The time indicating operation is conducted with the crown SW pushed down.

When a starting operation is performed on the start/switch ASW included by the external operating member 312, the control circuit 303 starts the time measurement operation based on the timepiece signal, and each time a predetermined measurement time indicating cycle arrives, the drive pulse generation circuit 304 controls the chronograph motor 308 so as to rotate the same via the motor drive circuit 305. As a result, the chronograph motor 308 rotates the chronograph hands 314, 318, 319 via the chronograph hand train wheel 309 at the measurement time indicating cycle. When a stopping operation is performed on the start/stop switch ASW, the control circuit 303 stops the time measuring operation, and controls the motor drive circuit 305 to stop the rotation of the chronograph hands 314, 318, 319.

When in the stop state, resetting operation is performed on the reset switch BSW included by the external operating member 312, the control circuit 303 resets the time measurement counter to restore the same to the initial state, and a mechanical mechanism (not shown) performs zero-restoring and setting on the chronograph hands 314, 318, 319 to attain the initial state.

When initial starting is effected through the replacement of the battery 320 or the supply of the system reset signal to the system reset terminal AC, there is performed an initialization on the hardware as a whole (e.g., initialization of a demonstration time counter for measuring the time that the demonstration hand movement is effected, an n-second counter, and an n-second pulse counter) (step S500).

Next, when an interrupt effected at a cycle of 1 Hz is permitted, the control circuit 303 performs the 1 Hz interrupt processing of FIG. 6 (step S501), and when an interrupt through the operation of the crown SW (KEY interrupt) is permitted, it performs the crown interrupt processing of FIG. 8 (step S502).

Next, in the case of a state in which the crown SW has been pushed in (a state in which the crown SW has been pushed in, that is, a state in which the crown is at the 0th step), the control circuit 303 is restored to the former state after giving an instruction to perform demonstration (steps S503, S505, S506). When it is judged in the processing step S503 that the crown SW is in a drawn-out state (a state in which crown SW has been drawn out), the procedure advances to the processing step S506 after an instruction to prepare for demonstration has been given (step S504).

In the 1 Hz interrupt processing of FIG. 6, when it is judged that the crown SW is in the pushed-in state (step S600), the control circuit 303 subtracts one second from a demonstration time counter (not shown) in the control circuit 303 (step S602), in the case that there is an instruction to perform normal indicating operation (instruction for demonstration) (step S601). The demonstration time counter is a counter for counting the period of time that the normal indicating operation is performed (i.e., the period of time that the demonstration hand movement is performed); in this embodiment, the period of time that the normal indicating operation is performed is set to 10 seconds, so that a 10-second counter is used as the demonstration time counter.

When the counter value of the demonstration time counter has not been reduced to zero, that is, the normal indicating operation has not been performed for the predetermined period of time (10 seconds) yet (step S603), the control circuit 303 subtracts one second, which is the time corresponding to one cycle, from the n-second counter (not shown) in the control circuit 303 (step S604). The n-second counter is a counter for performing time measurement to check whether or not the n seconds (which is 2 seconds in this embodiment) of the n-second hand movement for performing normal indicating operation have elapsed, that is, whether or not the hand movement timing of n-second hand movement has arrived.

When it is judged that the count value of the n-second counter has been reduced to zero, that is, the driving timing of n-second hand movement has arrived (step S605), the control circuit 303 sets the count value of the n-second counter to n (step S606), and gives an instruction to drive with the unused pulses (residual pulses) (step S607). Here, in this embodiment, the n of the n-second hand movement is 2, and an instruction is given to perform driving with the residual pulses.

Next, the control circuit 303 subtracts 1 from the n-second pulse counter (step S608), and is restored to the former state after driving the time motor 310 once (steps S610, S611). When performing the residual drive of the second drive onward after the processing step, the control circuit 303 performs the 8 Hz interrupt processing of FIG. 7 at a cycle of 8 Hz to perform driving in the interrupt processing (step S609).

When it is judged in the processing step S605 that the count value of the n-second counter has not been reduced to zero, the control circuit 303 advances to the processing step S611. When it is judged in the processing step S603 that the count value of the demonstration time counter has been reduced to zero, the control circuit 303 deletes the instruction for demonstration (step S612), and then advances to the processing step S610. When it is judged in the processing step S601 that there is no instruction for demonstration, the control circuit 303 advances to the processing step S610. When, in the processing step S600, the crown SW is in the drawn-out state, the control circuit 303 immediately advances to the processing step S611.

When it is judged in the 8 Hz interrupt processing of FIG. 7 that no residual drive pulse instruction has been given (step S700), the control circuit 303 drives the time second hand 317 via the drive pulse generation circuit 304 and the motor drive circuit 306 to perform the normal indicating operation (step S701), and then subtracts 1 from the n-pulse counter (step S702). In the case of 2-second hand movement (n=2), the second driving of the time second hand 317 is effected here.

When it is judged that the count value of the n-second pulse counter has been reduced to zero (step S703), the control circuit 303 cancels the residual pulse drive instruction (step S704). Here, in the case of 2-second hand movement, the count value of the n-second pulse counter is judged to be zero. Next, the control circuit 303 sets the count value of the n-second pulse counter to n (step S705), and prohibits 8 Hz interrupt before being restored to the former state (steps S706, S707).

When it is judged in the processing step S703 that the count value of the n-second pulse counter is not zero, the control circuit 303 advances to the processing step S707. For example, in the case of 3-second hand movement (n=3), “1” still remains at this point in time, so that the procedure returns from the processing step S707 to the processing step S700.

When it is judged in the processing step S700 that no residual pulse drive instruction has been given, the control circuit 303 advances to the processing step S706.

When it is judged that the crown SW is in the pushed-in state in a crown interrupt processing of FIG. 8 (step S800), the control circuit 303 cancels a demonstration preparation instruction (step S802) in the case in which such demonstration preparation instruction has been given (step S801).

Next, the control circuit 303 gives an instruction for demonstration (step S803), and resets a timer frequency division step (each counter mentioned above) before being restored to the former state (steps S804, S805).

When no demonstration preparation instruction has been given in the processing step S801, the control circuit 303 advances to the processing step S804. When it is judged in the processing step S800 that the crown SW is in the drawn-out state, the control circuit 303 cancels the instruction for demonstration (step S806), and cancels the residual pulse drive instruction (step S807) to thereby cancel the normal indicating operation before advancing to the processing step S805.

As described above, in the chronograph timepiece of the other embodiment of the present invention, the driving of the time hands including the time second hand and the driving of the chronograph hands are effected electrically by the motors 308, 310, setting is effected in the reset state, by a mechanical mechanism so that the chronograph hands 314, 318, 319 may not move, and the driving of the chronograph hands 314, 318, 319 is effected after the releasing of the setting by the mechanical mechanism, wherein there is provided a normal indicating drive unit which, when initial starting is effected, drives the time second hand 317 at a cycle different from the time indicating cycle, thereby indicating that the initial starting has been normally effected.

Thus, as in the first embodiment described above, it is possible to make sure that the chronograph timepiece operates normally at the time of an initial starting operation such as system resetting without having to perform a difficult operation or the like.

Further, the time hand is moved for n seconds in order to perform the normal indicating operation indicating that the initial starting operation has been normally completed, so that there is no need to provide such a complicated construction as will reverse the time hand, making it possible to perform the normal indicating operation with a simple construction. Further, in the normal indicating operation, instead of causing one rotation through fast-forwarding, n-second hand movement is effected, so that it is possible to eliminate advancement of the actual time through the normal indicating operation, making it possible to perform an accurate time display.

Further, it is possible to effect n-second hand movement (n is, for example, 2, 3, 4, 5, 6, 10, 12, 15, 20, or 30 seconds) during a period of time of less than 1 minute of demonstration hand movement. Further, the period of time for demonstration hand movement may be arbitrary; in this case, the cancelling of the demonstration hand movement may be effected by operating the external operating member 312. The period of time for demonstration hand movement may be a predetermined fixed time.

The present invention is applicable to various types of chronograph timepiece in which the driving of the time hands and the chronograph hands is electrically effected by motors and in which, in the reset state, setting is effected by a mechanical mechanism so that the chronograph hands may not move, with the driving of the chronograph hands being effected after the releasing of the setting by the mechanical mechanism.

What is claimed is:

1. A chronograph timepiece of the type in which a time hand and a chronograph hand are electrically driven by a motor and in which, in a reset state, setting is effected by mechanical mechanism so that the chronograph hand may not move, with the chronograph hand being driven after the releasing of the setting by the mechanical mechanism,
wherein there is provided a control means permitting the time hand to perform a predetermined normal indicating operation when initial starting is effected.

2. A chronograph timepiece according to claim 1, further comprising an operating means, wherein when initial starting is effected with the operating means being in a predetermined state, the control means permits the time hand to perform the normal indicating operation.

3. A chronograph timepiece according to claim 1, further comprising an operating means, wherein when initial starting is effected with the operating means not undergoing a predetermined operation, the control means permits the time hand to perform the normal indicating operation.

4. A chronograph timepiece according to claim 1, wherein the control means moves the time hand until the time hand performs normal indicating operation.

5. A chronograph timepiece according to claim 1, wherein chronograph operation is possible until the time hand performs normal indicating operation.

6. A chronograph timepiece according to claim 3, wherein the operating means has a start/stop switch giving an instruction to start and stop a chronograph function and a reset switch giving an instruction to reset the chronograph function; and
when initial starting is effected, with both the start/stop switch and the reset switch not being simultaneously operated, the control means permits the time hand to perform the normal indicating operation.

7. A chronograph timepiece of the type in which time hands including a time second hand and a chronograph hand are electrically driven by a motor and in which, in a reset state, setting is effected by a mechanical mechanism so that the chronograph hand may not move, with the chronograph hand being driven after the releasing of the setting by the mechanical mechanism,
wherein there is provided a normal indicating drive means which, when initial starting is effected, drives the time second hand at a cycle different from a time indicating cycle, thereby performing a normal indicating operation.

8. A chronograph timepiece according to claim 7, further comprising a crown,
wherein when initial starting is effected with the crown being in a pushed-in state, the normal indicating drive means drives the time second hand at a cycle different from the time indicating cycle, thereby performing the normal indicating operation.

9. A chronograph timepiece according to claim 7, further comprising a crown,
wherein when initial starting is effected with the crown being in a drawn-out state, the normal indicating drive means drives the time second hand at a cycle different from the time indicating cycle when the crown is pushed in, thereby performing the normal indicating operation.

10. A chronograph timepiece according to claim 8, further comprising a crown,
wherein when initial starting is effected with the crown being in a drawn-out state, the normal indicating drive means drives the time second hand at a cycle different from the time indicating cycle when the crown is pushed in, thereby performing the normal indicating operation.

11. A chronograph timepiece according to claim 7, further comprising a crown,
wherein when the crown is drawn out after a predetermined period of time has elapsed from the start of a normal indicating operation or during the normal indicating operation, the normal indicating drive means completes the normal indicating operation.

12. A chronograph timepiece according to claim 8, further comprising a crown,
wherein when the crown is drawn out after a predetermined period of time has elapsed from the start of a normal indicating operation or during the normal indicating operation, the normal indicating drive means completes the normal indicating operation.

13. A chronograph timepiece according to claim 9, further comprising a crown,
wherein when the crown is drawn out after a predetermined period of time has elapsed from the start of a normal indicating operation or during the normal indicating operation, the normal indicating drive means completes the normal indicating operation.

14. A chronograph timepiece according to claim 10, further comprising a crown,
wherein when the crown is drawn out after a predetermined period of time has elapsed from the start of a normal indicating operation or during the normal indicating operation, the normal indicating drive means completes the normal indicating operation.

15. A chronograph timepiece according to claim 7, wherein the normal indicating drive means collectively drives, each time a predetermined seconds have elapsed and within a predetermined period of time before the passage of the predetermined seconds, the time second hand by an amount corresponding to the predetermined seconds, thereby performing the normal indicating operation.

16. A chronograph timepiece according to claim 8, wherein the normal indicating drive means collectively drives, each time a predetermined seconds have elapsed and within a predetermined period of time before the passage of the predetermined seconds, the time second hand by an amount corresponding to the predetermined seconds, thereby performing the normal indicating operation.

17. A chronograph timepiece according to claim 9, wherein the normal indicating drive means collectively drives, each time a predetermined seconds have elapsed and within a predetermined period of time before the passage of the predetermined seconds, the time second hand by an amount corresponding to the predetermined seconds, thereby performing the normal indicating operation.

18. A chronograph timepiece according to claim 10, wherein the normal indicating drive means collectively drives, each time a predetermined seconds have elapsed and within a predetermined period of time before the passage of the predetermined seconds, the time second hand by an amount corresponding to the predetermined seconds, thereby performing the normal indicating operation.

19. A chronograph timepiece according to claim 1, further comprising a system reset terminal, wherein the initial starting is effected by inputting a system reset signal to the system reset terminal.

20. A chronograph timepiece according to claim 1, wherein the chronograph timepiece operates using a battery as a power source, with the initial starting being effected through replacement of the battery.
